(19) United States
(12) Patent Application Publication
(10) Pub. No.: US 2023/0027139 A1
(43) Pub. Date: Jan. 26, 2023

(54) ROTOR FOR AN ELECTRIC MACHINE, ELECTRIC MACHINE, AND METHOD FOR OPERATING AN ELECTRIC MACHINE

(71) Applicant: Knorr-Bremse Systeme Fuer Nutzfahrzeuge GmbH, Muenchen (DE)

(72) Inventors: Noel Mathae, Stuttgart (DE); Dordo Stankovic, Muenchen (DE); Zeger Bontinck, Muehlacker (DE)

(21) Appl. No.: 17/864,119

(22) Filed: Jul. 13, 2022

(30) Foreign Application Priority Data
Jul. 21, 2021 (DE) 10 2021 118 832.6

(51) Int. Cl. H02K 1/276; H02K 1/02

(52) U.S. Cl. CPC H02K 1/276; H02K 1/02

(57) ABSTRACT

A rotor for an electric machine, wherein the electric machine includes a stator and the rotor, which is rotatable relative to the stator. The rotor includes a plurality of permanent magnets and a first rotor portion, which is formed from a first material having a first magnetic permeability. The first rotor portion includes at least one sub-portion of the rotor facing the stator in an operationally ready state of the electric machine. The permanent magnets are arranged at least in part in the first rotor portion. The rotor also includes a second rotor portion, which is formed from a second material having a second magnetic permeability which is lower than the first magnetic permeability. The second rotor portion includes a sub-portion of the rotor facing away from the stator in the operationally ready state of the electric machine.

### RELATED APPLICATION INFORMATION

The present application claims priority to and the benefit of German patent application no. 10 2021 118 832.6, which was filed in Germany on Jul. 21, 2021, the disclosure of which is incorporated herein by reference.

### FIELD OF THE INVENTION

The present invention relates to a rotor for an electric machine, to an electric machine, and to a method for operating an electric machine.

### BACKGROUND INFORMATION

Some configurations of rotors for electric machines embodied as internal rotors attempt, for example, to operate an inner part of the rotor laminations in saturation. In particular, small iron bridges may therefore be incorporated within such a conventional rotor. These bridges, for example, may be so thin that the core laminations are saturated, i.e., the magnetic permeability of these regions may approximate the value of air. Other configurations may provide the bridges for example merely in regions having the same polarization. However, in order to ensure structural stability, it may be necessary here to incorporate small iron regions above the magnets.

### SUMMARY OF THE INVENTION

Against this background, it is an object of the present invention to create an improved rotor for an electric machine, an improved electric machine, and an improved method for operating an electric machine.

This object may be achieved by a rotor for an electric machine, by an electric machine, and by a method for operating an electric machine as described herein.

According to embodiments, an inner flux barrier may in particular be provided in rotors for electric motors with permanent magnets, wherein a concentration of the magnetic flux may be utilized. Here, radially inner regions of the rotor, for example, may be formed from a material having a lower magnetic permeability. For example, steel laminations, however, may be used as material in the regions between and above the magnets. The permanent magnets may be embedded here at least in part in sheet steel laminations.

In accordance with embodiments, in particular in electric motors having permanent magnets, a concentration of the magnetic flux towards the air gap is brought about by a rotor construction of the type presented here in order to achieve efficient use of the magnets. It is thus possible to prevent field lines of different poles from connecting at parts of the magnets facing away from the stator, i.e. in the vicinity of a rotor shaft in the case of an internal rotor. In particular, a magnetic permeability in this rotor portion, for example compared with iron, can be approximated with that of air in the air gap. In particular, it can thus also be achieved in particular that a maximum proportion of the magnetic flux can leave the rotor and thus can contribute to torque generation. A magnet volume can thus be utilized to the maximum for torque generation.

In other words, practically the entire magnetic flux that is generated by the magnets can be forced into the air gap and into the stator laminations. The advantage lies in that a higher torque of the motor can be achieved with the same amount of magnet material or, for a motor that should provide a given torque, a smaller volume of permanent magnet material is required and thus a more economical configuration of the motor or of the electric machine can be achieved. Therefore, the magnetic flux can be forced towards the air gap of the electric machine and the stator. This may lead to an improved interaction between the rotor and the stator and thus to an improved torque.

A rotor for an electric machine, wherein the electric machine comprises a stator and the rotor, which is rotatable relative to the stator, has the following features:

a plurality of permanent magnets;

a first rotor portion, which is formed from a first material having a first magnetic permeability, wherein the first rotor portion comprises at least one sub-portion of the rotor facing the stator in an operationally ready state of the electric machine, wherein the permanent magnets are arranged at least in part in the first rotor portion; and

a second rotor portion, which is formed from a second material having a second magnetic permeability which is lower than the first magnetic permeability, wherein the second rotor portion comprises a sub-portion of the rotor facing away from the stator in the operationally ready state of the electric machine.

The electric machine may be referred to as an electric motor. The stator may comprise at least one electric coil for interacting with the permanent magnets. There may be an air gap located between the rotor and the stator.

In accordance with an embodiment, the second rotor portion may be formed from a diamagnetic and/or paramagnetic material, in particular from aluminum. Such an embodiment offers the advantage that the magnetic flux can be directed particularly effectively towards the air gap and the stator. Furthermore, with use in the second rotor portion of the rotor of diamagnetic and/or paramagnetic materials, such as aluminum, with a lower mass density than iron, an inertia of the rotor can be reduced. This may also reduce a start-up speed of the motor.

The first rotor portion may also be formed from steel and additionally or alternatively iron. In particular, the first rotor portion may comprise sheet steel laminations, a laminated core, and additionally or alternatively iron bridges. Such an embodiment offers the advantage that the magnetic flux in the first rotor portion can be concentrated towards the air gap and the stator.

Furthermore, the first rotor portion may extend between the permanent magnets. The permanent magnets may thus be embedded at least in part in the first rotor portion. Such an embodiment offers the advantage that a magnetic saturation can be achieved during operation of the electric machine.

In particular, the permanent magnets may be arranged in a spoke configuration. Here, axes of longitudinal extent of the permanent magnets may be oriented radially in relation to the rotor. Such an embodiment offers the advantage that a dense arrangement of the magnets and thus a high number of pole pairs can be achieved in order to be able to achieve a high rated torque.

In accordance with an embodiment, the rotor may be configured to be surrounded rotatably, at least in part, by the stator. Here, the first rotor portion may comprise a radially outer sub-portion of the rotor. The second rotor portion may comprise a radially inner sub-portion of the rotor. The electric machine may be embodied here as an internal rotor. Such an embodiment offers the advantage that an application for a machine type frequently used in drive technology is made possible.

An electric machine has the following features:

a stator; and

an embodiment of a rotor as described herein, wherein the rotor is rotatable relative to the stator.

The electric machine may be embodied as an internal rotor or external rotor. An embodiment of the rotor described herein may be employed or used advantageously in conjunction with the electric machine in order to direct the magnetic flux from the permanent magnets to the stator.

A method for operating an embodiment of an electric machine described herein has the following step:

supplying an electric current into at least one electric coil of the stator in order to bring about a rotary motion of the rotor relative to the stator.

Exemplary embodiments of the approach presented here are explained in greater detail in the following description with reference to the figures.

### BRIEF DESCRIPTIONS OF THE DRAWINGS

FIG. 1 shows a schematic depiction of a magnetic field of an electric machine on the basis of a sectional depiction of the electric machine.

FIG. 2 shows a schematic depiction of an exemplary embodiment of an electric machine.

FIG. 3 shows a schematic depiction of a magnetic field of an exemplary embodiment of an electric machine on the basis of a sectional depiction of the electric machine.

FIG. 4 shows a schematic torque-angular position chart for an exemplary embodiment of an electric machine.

FIG. 5 shows a flow diagram of an exemplary embodiment of a method for operating an electric machine.

### DETAILED DESCRIPTION

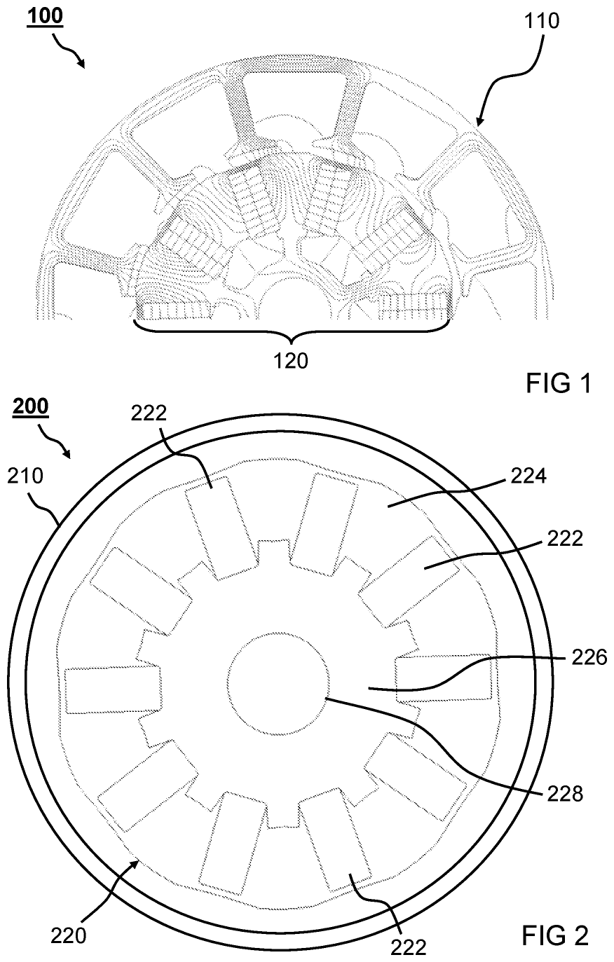

FIG. 1 shows a schematic depiction of a magnetic field of an electric machine 100 on the basis of a sectional depiction of the electric machine 100. The electric machine 100 comprises a stator 110 and a rotor 120. Only a sub-portion of the electric machine 100 is shown in the depiction of FIG. 1.

FIG. 2 shows a schematic depiction of an exemplary embodiment of an electric machine 200. Here, the electric machine 200 is shown in particular in a schematic cross-sectional depiction. The electric machine 200 comprises a stator 210 and a rotor 220. The rotor 220 is rotatable, more specifically arranged or mounted rotatably, relative to the stator. The rotor 220 comprises a plurality of permanent magnets 222, a first rotor portion 224 and a second rotor portion 226. Furthermore, a rotor shaft 228 of the rotor 220 is shown. There is a gap or air gap located between the stator 210 and the rotor 220.

The rotor 220 is divided into the first rotor portion 224 and the second rotor portion 226. The first rotor portion 224 is formed from a first material having a first magnetic permeability. Here, the first rotor portion 224 comprises at least one sub-portion of the rotor 220 facing the stator 210. The permanent magnets 222 are arranged or embedded at least in part in the first rotor portion 224. The second rotor portion 226 is formed from a second material having a second magnetic permeability which is lower than the first magnetic permeability of the first material of the first rotor portion 224. Here, the second rotor portion 226 comprises a sub-portion of the rotor 220 facing away from the stator 210.

According to the exemplary embodiment shown in FIG. 2, the electric machine 200 is embodied as an internal-rotor electric motor. Here, the rotor 220 is configured to be surrounded rotatably, at least in part, by the stator 210. The first rotor portion 224 comprises a radially outer sub-portion of the rotor 220, wherein the second rotor portion 226 comprises a radially inner sub-portion of the rotor 220. Furthermore, in accordance with the exemplary embodiment shown in FIG. 2, the permanent magnets 222 are arranged in a spoke configuration. Here, axes of longitudinal extent of the permanent magnets 222 are oriented radially in relation to the rotor 220. In particular, the first rotor portion 224 extends between the permanent magnets 222. The second rotor portion 226 is formed for example from a diamagnetic and/or paramagnetic material, in particular aluminum. The first rotor portion 224 is formed in particular from steel and/or from iron.

In other words, FIG. 2 thus shows a schematic cross-section of an electric machine comprising a rotor 220 having permanent magnets 222 in a spoke orientation. The first rotor portion 224 for example comprises iron laminations and the second rotor portion 226 comprises aluminum, for example, as diamagnetic and/or paramagnetic material of lower magnetic permeability.

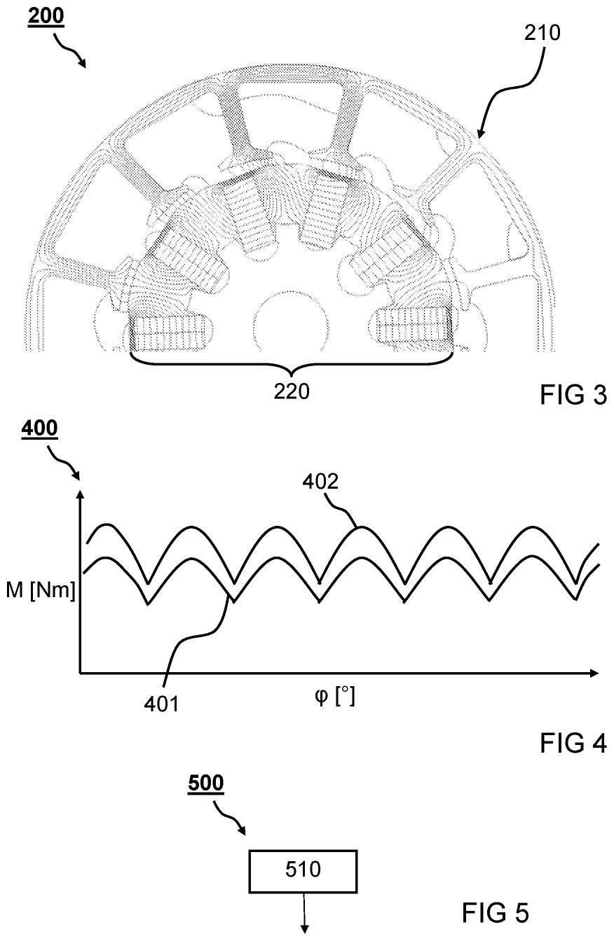

FIG. 3 shows a schematic depiction of a magnetic field of an exemplary embodiment of an electric machine 200 on the basis of a sectional depiction of the electric machine 200. Here, a sub-portion of the electric machine 200 is shown in the depiction of FIG. 3. The electric machine corresponds to or assimilates here the electric machine from one of the previously described figures, more specifically one of FIGS. 2 to 3. In the depiction of FIG. 3, only the stator 210 and the rotor 220 of the electric machine 200 are explicitly denoted.

In other words, FIG. 3 shows a magnetic field of a configuration of an electric machine 200 or of an electric motor according to an exemplary embodiment. Here too, the electric motor is embodied as an internal rotor. The radially inner part of the rotor 220 is constructed for example using aluminum. In particular, compared with FIG. 1, it can be seen that a reduced or minimized number of magnetic field lines enter the radially inner regions and an increased or maximized amount of magnetic flux passes into the air gap and into the stator 210.

FIG. 4 shows a schematic torque-angular position chart 400 for an exemplary embodiment of an electric machine. The electric machine corresponds to or assimilates here the electric machine from one of the previously described figures, more specifically one of FIGS. 2 to 3. An angular position or a rotary angle φ of the rotor of the electric machine in degrees [°] is plotted on the x-axis, and a torque M of the electric machine in Newton-meters [Nm] is plotted on the y-axis. The torque M is, for example, the mean output torque of an electric machine embodied as an electric motor. In the chart 400, a first graph 401 is shown as a comparison graph for a conventional electric machine and a second graph 402 is shown for the exemplary embodiment of the electric machine.

More specifically, FIG. 4 shows a comparison of torques M of a conventional electric machine, for example such as that from FIG. 1, and of an electric machine according to an exemplary embodiment, for example such as that from FIG. 2 and/or FIG. 3. It can be seen that the torque M or mean output torque of the exemplary embodiment of the electric machine is higher than a torque generated by a conventional electric machine. Thus, the first graph 401 is located between the second graph 402 and the x-axis. The mean output torque of the exemplary embodiment of the electric machine may be, for example, approximately 7.5% higher than a torque generated by a conventional electric machine.

FIG. 5 shows a flow diagram of an exemplary embodiment of a method 500 for operating an electric machine. The electric machine corresponds to or assimilates here the electric machine from one of the previously described figures, more specifically one of FIGS. 2 to 3. The electric machine thus comprises a stator and a rotor, wherein the rotor is rotatable relative to the stator. The rotor is constructed here in accordance with an exemplary embodiment described herein. The operating method 500 comprises a step 510 of supplying an electric current into at least one electric coil of the stator in order to bring about a rotary motion of the rotor relative to the stator. The electric machine is operable here by electric motor control methods in the art.

### THE LIST OF REFERENCE SIGNS IS AS FOLLOWS

100 electric machine
110 stator
120 rotor
200 electric machine
210 stator
220 rotor
222 permanent magnet
224 first rotor portion
226 second rotor portion
228 rotor shaft
400 torque-angular position chart
401 first graph
402 second graph
M torque
φ angular position or rotary angle
500 method for operating an electric machine
510 supply step

What is claimed is:

1. A rotor for an electric machine, having a stator and the rotor, which is rotatable relative to the stator, comprising:
a plurality of permanent magnets;
a first rotor portion, which is formed from a first material having a first magnetic permeability, wherein the first rotor portion includes at least one sub-portion of the rotor facing the stator in an operationally ready state of the electric machine, wherein the permanent magnets are arranged at least in part in the first rotor portion; and
a second rotor portion, which is formed from a second material having a second magnetic permeability which is lower than the first magnetic permeability, wherein the second rotor portion includes a sub-portion of the rotor facing away from the stator in the operationally ready state of the electric machine.

2. The rotor of claim 1, wherein the second rotor portion is formed from a diamagnetic and/or paramagnetic material.

3. The rotor of claim 1, wherein the first rotor portion is formed from steel and/or iron.

4. The rotor of claim 1, wherein the first rotor portion extends between the permanent magnets.

5. The rotor of claim 1, wherein the permanent magnets are arranged in a spoke configuration, and wherein axes of longitudinal extent of the permanent magnets are oriented radially in relation to the rotor.

6. The rotor of claim 1, wherein the rotor is configured to be surrounded rotatably, at least in part, by the stator, wherein the first rotor portion includes a radially outer sub-portion of the rotor, and wherein the second rotor portion includes a radially inner sub-portion of the rotor.

7. An electric machine, comprising:
a stator; and
a rotor, which is rotatable relative to the stator;
wherein the rotor includes:
a plurality of permanent magnets;
a first rotor portion, which is formed from a first material having a first magnetic permeability, wherein the first rotor portion includes at least one sub-portion of the rotor facing the stator in an operationally ready state of the electric machine, wherein the permanent magnets are arranged at least in part in the first rotor portion; and
a second rotor portion, which is formed from a second material having a second magnetic permeability which is lower than the first magnetic permeability, wherein the second rotor portion includes a sub-portion of the rotor facing away from the stator in the operationally ready state of the electric machine.

8. A method for operating an electric machine, the method comprising:
supplying an electric current into at least one electric coil of a stator to bring about a rotary motion of a rotor relative to the stator;
wherein the electric machine includes:
the stator; and
the rotor, which is rotatable relative to the stator;
wherein the rotor includes:
a plurality of permanent magnets;
a first rotor portion, which is formed from a first material having a first magnetic permeability, wherein the first rotor portion includes at least one sub-portion of the rotor facing the stator in an operationally ready state of the electric machine, wherein the permanent magnets are arranged at least in part in the first rotor portion; and
a second rotor portion, which is formed from a second material having a second magnetic permeability which is lower than the first magnetic permeability, wherein the second rotor portion includes a sub-portion of the rotor facing away from the stator in the operationally ready state of the electric machine.

9. The rotor of claim 1, wherein the second rotor portion is formed from a diamagnetic and/or paramagnetic material, which includes aluminum.
